(19) United States
(12) Patent Application Publication
(10) Pub. No.: US 2009/0096251 A1
(43) Pub. Date: Apr. 16, 2009

(54) SECURING MECHANISM

(75) Inventors: Michael C. Niezur, Medison Heights, MI (US); Taylor S. Robertson, Metamora, MI (US)

Correspondence Address: RADER, FISHMAN & GRAUER PLLC, 39533 WOODWARD AVENUE, SUITE 140, BLOOMFIELD HILLS, MI, 48304-0610, US

(73) Assignee: Sika Technology AG

(21) Appl. No.: 11/873,233

(22) Filed: Oct. 16, 2007

(51) Int. Cl. B60R 27/00

(52) U.S. Cl. 296/187.02

(57) ABSTRACT

A mechanism suitable for assisting in the securing of expansible material to a carrier is disclosed.

### FIELD

The present disclosure relates to mechanisms for securing expansible material onto carriers that are placeable into structural members for any of a number of purposes, including but not limited to reinforcement applications or baffling applications.

### BACKGROUND

Mechanical structures are present in automobiles, household appliances, flooring, machine shells, washer/dryers, airplanes, boats, or various tools. Many mechanical structures contain cavities. It is often desirable to place a component comprising a carrier with expansible material thereon into such cavities for a variety of applications. Such applications include attenuation of noise and vibration and absorbing energy in a crash, to name a few.

It is also desirable to secure expansible material on a carrier so that the component can be readily handled and stored. A securing mechanism can assist in assuring that the expansible material be applied in the correct position on the carrier. A securing mechanism can also provide additional stability to the expansible materials disposed on the carrier prior to expansion. A securing mechanism can further assist in preventing the expansible material from peeling away from a surface of the carrier while the component is being stored or handled.

### BRIEF DESCRIPTION OF THE DRAWINGS

The foregoing brief description will be understood more completely from the following detailed description of the exemplary drawings, in which:

FIG. 1 is a perspective view of a securing mechanism on a carrier.

FIG. 2 is the securing mechanism of FIG. 1 with expansible material on the carrier.

FIG. 3 is a perspective view of a securing mechanism on a carrier.

FIG. 4 is the securing mechanism of FIG. 3 with expansible material on the carrier.

FIG. 5 is a perspective view of a securing mechanism on a carrier.

FIG. 6 is a close-up perspective view of an alternative angle of the securing mechanism of FIG. 5.

FIG. 7 is the securing mechanism of FIG. 5 with expansible material on the carrier.

### DETAILED DESCRIPTION OF THE DRAWINGS

The figures disclosed and described herein are illustrative examples of the appended claims, and are not intended to be limiting.

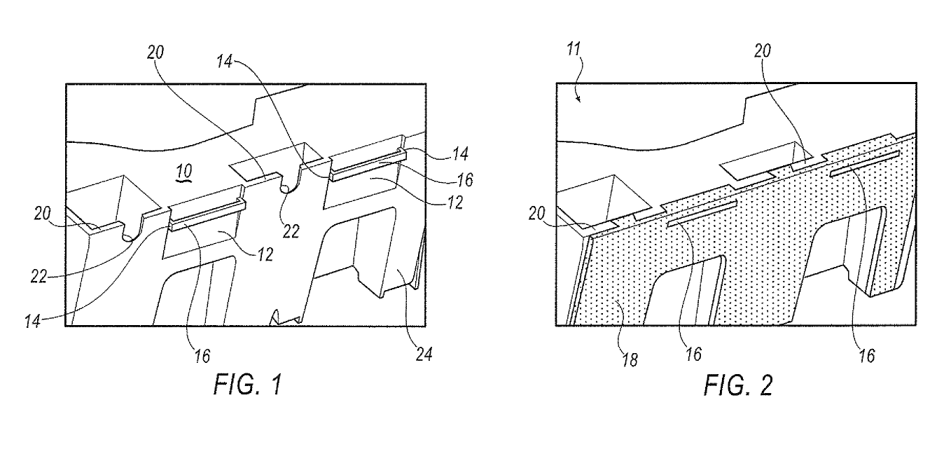

FIGS. 1 and 2 depict a mechanism that can be used to secure expansible materials on a carrier 10 to form a component 11. A first surface 24 of the carrier 10 includes a recess 12 and opposing arms 14. A bar 16 spans the opposing arms 14, creating a gap between bar 16 and recess 12. The opposing arms 14 may also be oriented outside the recess 12 or a combination of both in and out of the recess 12. As shown in FIG. 2, expansible material 18 fills the gap. The bar 16, at least in part, assists in retaining the expansible material 18 in place. In particular, the bar 16 may help prevent the expansible material 18 from peeling away from surface 24.

Additionally, surface 24 has a first edge 20. First edge 20 has a groove 22 extending therethrough. While FIG. 1 shows groove 22 with beveling, groove 22 may alternatively be shaped without beveling. As shown in FIG. 2, when expansible material 18 is initially applied to surface 24, the expansible material 18 extends through the groove 22 and around the beveling of the groove 22. Thus, the beveling of the groove 22 may help prevent the expansible material 18 from peeling away from surface 24.

The securing mechanism depicted in FIGS. 1 and 2 may be integrally formed with the carrier 10 using any method, including injection molding. Together the carrier 10 and expansible material 18 form a component 11 that can serve any number of purposes depending on the nature of the expansible material 18. The expansible material can be among other things a reinforcement material or a baffle material.

Expansible reinforcement materials may include thermosetting and thermoplastic polymers, rubbers such as SBS block-copolymer, tackifiers, curing agents, chemical and/or physical blowing agents, rheology agents, fillers, pigments, and other ingredients. The Sika Corporation sells thermally expansible reinforcer materials under the trade name SIKAREINFORCER that are suitable. A series of these thermally expansible reinforcer materials, owned by the Sika Corporation, are described in the U.S. Pat. No. 6,387,470, incorporated herein by reference in its entirety. Other suitable expansible reinforcement materials are disclosed in U.S. Published Patent Application No. 2007/0110951, incorporated herein by reference in its entirety.

Expansible baffle materials may include any known expansible baffle material that is capable of expanding and substantially sealing off a cavity to reduce the ability of noise to carry through the cavity. Such baffle materials may include epoxy resin, thermosetting and thermoplastic polymers (including but not limited to ethylene vinyl acetate), tackifiers, curing agents, chemical and/or physical blowing agents, rheology agents, fillers, pigments, and other ingredients. The Sika Corporation sells suitable thermally expansible baffle materials under the SIKABAFFLE trade name, which are described in U.S. Pat. Nos. 5,266,133 and 5,373,027, both of which are incorporated herein by reference in their entireties.

Any process may be used to dispose expansible materials on a surface of a carrier. Such processes include but are not limited to overmolding and/or adhering or otherwise affixing strips or other shapes of expansible material on a surface of a carrier.

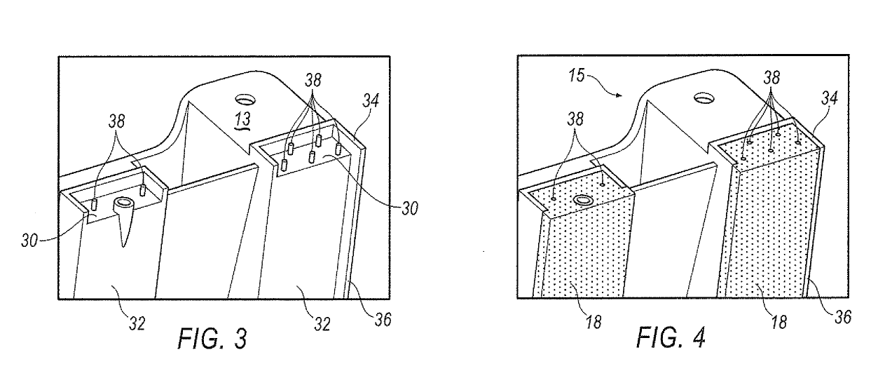

FIGS. 3 and 4 disclose another suitable securing mechanism for retaining expansible material 18 on carrier 13 to form component 15. In FIG. 3, a first area 30 and a second area 32 are shown. In FIGS. 3 and 4, area 30 and 32 are perpendicular or substantially perpendicular. Other geometries are contemplated and suitable so long as the first area 30 is not parallel to the second area 32. As depicted, a first rim 34 at least partially defines a perimeter of first area 30 and a second rim 36 at least partially defines a second area 32. Embodiments are contemplated in which there maybe more than one first rim 34 and more than one second rim 36. Embodiments are also contemplated wherein there is no second rim 36.

At least one protuberance 38 extends from first area 30. More than one protuberance 38 may extend from first area 30 if desired. Though depicted as substantially cylindrical, protuberances 38 may be of any shape and size. Protuberances 38 may be formed integrally with the carrier 13 or may be formed separately and later attached to the carrier 13, using any necessary or suitable method of attachment.

As shown in FIG. 4, expansible material 18 is on areas 30 and 32, and expansible material 18 extends through the first and second areas and surrounds or substantially surrounds protuberances 38. The expansible material 18 is held in place on the component 15 at least in part by the protuberances 38.

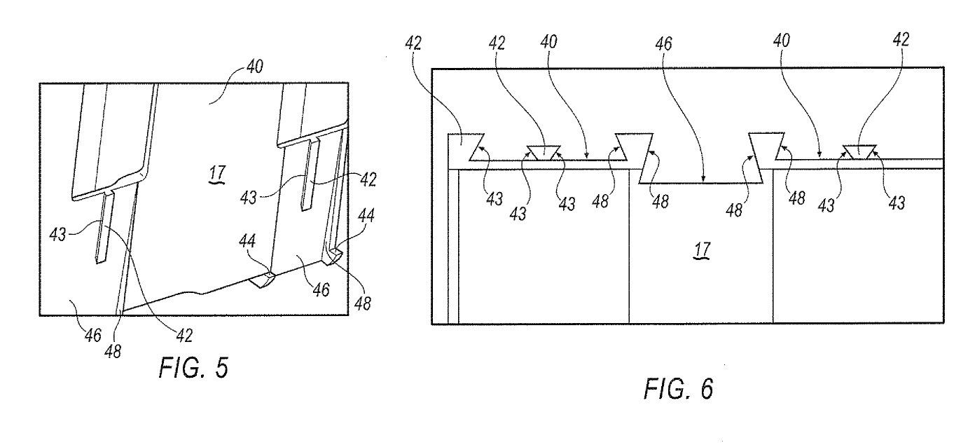

FIGS. 5-7 disclose yet another suitable securing mechanism for retaining expansible material 18 on a carrier 17 to form a component 19. FIG. 5 depicts a surface 40 of the carrier 17. Surface 40 includes at least one wedged band 42 which extends from surface 40. The wedged band 42 has at least one angled side 43. It is contemplated that the wedged band 42 can have more than one angled side 43. It is also contemplated that the wedged band 42 may vary in shape and size.

As the wedged band 42 extends from surface 40, the angled side 43 forms an angle with surface 40. The angle can be up to about 90 degrees. The angle can alternatively range from about 10 degrees to about 80 degrees or from about 20 degrees to about 70 degrees. The angle can be adjusted according to the degree of mechanical support desired to be provided by angled side 43 to secure the expansible material 18 on surface 40.

Surface 40 may optionally include at least one ledge 44. As depicted in FIG. 5, wedged band 42 is substantially perpendicular to ledge 44. The substantially perpendicular relationship among wedged band 42 and ledge 44 is merely exemplary, and many other orientations of the wedged bands and ledges are contemplated. Additionally, ledge 44 may be integrally formed with sidewall 48, as depicted in FIG. 5. However, the placement and arrangement of ledge 44 is merely exemplary. Any placement and arrangement of ledge 44 relative to surface 40 is contemplated.

As depicted, surface 40 includes two surface recess areas 46. It is contemplated that any number of surface recess areas could be used on carrier 17. The depicted recess areas 46 are not parallel to surface 40, but rather are on an incline. Recess areas 46 need not be on an incline. It is contemplated that the recess areas 46 may be parallel to the surface 40. The recess areas 46 can be of any desired shape and size, and may be flat or curved, regular or irregular. Wedged band 42 may protrude from recess area 46. Angled side 43 of wedged band 42 may also form an angle with recess area 46. The angle can be up to about 90 degrees. The angle can alternatively range from about 10 degrees to about 80 degrees or from about 20 degrees to about 70 degrees. The angle can be adjusted according to the degree of mechanical support desired to be provided by angled side 43 to secure the expansible material 18 on recess area 46.

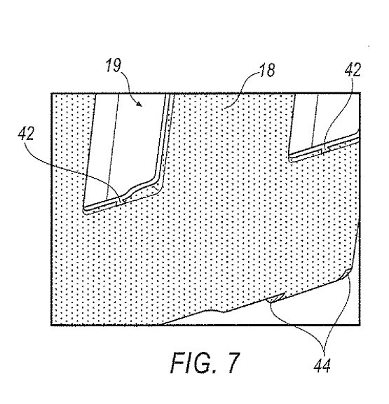

Surface 40 also has opposing sidewalls 48 protruding from the surface 40. As shown in FIG. 7, expansible material 18 is disposed on surface 40, including in surface recess areas 46 and spans the opposing sidewalls 48. The expansible material 18 also substantially surrounds wedged bands 42 and rests upon ledges 44. Together, wedged band 42 and ledge 44 may help in retaining expansible material 18 on surface 40.

Any of the securing mechanisms disclosed above may be implemented alone, in multiples, and/or in combination with any of the other securing mechanisms disclosed above on a carrier. It is further contemplated that the securing mechanisms disclosed above could be located on any surface of a carrier.

The appended claims have been particularly shown and described with reference to the foregoing embodiments, which are merely illustrative of the best modes for carrying out the invention defined by the appended claims. It should be understood by those skilled in the art that various alternatives to the embodiments described herein may be employed in practicing the invention defined by the appended claims without departing from the spirit and scope of the invention as defined in claims. The embodiments should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

With regard to the processes, methods, heuristics, etc. described herein, it should be understood that although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes described herein are provided for illustrating certain embodiments and should in no way be construed to limit the appended claims.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary.

What is claimed is:

1. A mechanism for securing expansible material to a carrier, comprising:
a recess in a wall of the carrier;
at least two opposing arms extending from the wall;
a bar connecting the at least two opposing arms, thereby creating a gap between the bar and the recess;
whereby expansible material is disposable in the gap and on non-recessed portions of the wall, such that the expansible material is securable at least in part by the bar.

2. The mechanism of claim 1, wherein the recess is not parallel to the wall.

3. The mechanism of claim 1, wherein the opposing arms extend from the recess in the wall.

4. The mechanism of claim 1, wherein the opposing arms extend from a region outside of the recess in the wall.

5. The mechanism of claim 1, wherein the securing mechanism further comprises:
a first edge of the wall having at least one beveled groove extending therethrough; and
whereby expansible material is extendable through at least a portion of at least one beveled groove.

6. A mechanism for securing expansible material to a carrier, comprising:
a first area of the carrier defined by at least one first rim;
at least one protuberance extending from the first area; and
a second area extending from the first area and being substantially perpendicular to the first area;
whereby expansible material is extendable through the first area and the second area, such that the expansible material is securable at least in part by at least one protuberance.

7. The mechanism of claim 6, wherein the second area is further defined by at least one second rim.

8. The mechanism of claim 6, wherein the expansible material is secured at least in part by a plurality of protuberances.

9. The mechanism of claim 6, wherein the protuberances are substantially cylindrical.

10. A mechanism for securing expansible material to a carrier, comprising:
a surface of the carrier having at least one wedged band thereon, the at least one wedged band having at least one angled side;
wherein expansible material is disposable on the surface and in contact with the surface and at least one angled side; and
wherein the expansible material is securable on the surface at least in part by at least one angled side.

11. The mechanism of claim 10, wherein the surface comprises at least one ledge substantially perpendicular to at least one wedged band and whereby expansible material is disposable on the surface and securable at least in part by at least one angled side and at least one ledge.

12. The mechanism of claim 10, wherein the surface comprises at least one recess area and wherein at least one wedged band protrudes from at least one recess area.

13. The mechanism of claim 10, wherein the surface of the carrier further comprises opposing sidewalls protruding from the surface such that expansible material spans the surface between the opposing sidewalls.

14. A mechanism for securing expansible material to a carrier, comprising:
a first area of the carrier defined by at least one first rim;
at least one protuberance extending from the first area;
a second area extending from the first area and being substantially perpendicular to the first area;
a recess in a wall of the carrier wherein at least a portion of the wall occupies the second area;
at least two opposing arms extending from the wall;
a bar connecting the at least two opposing arms, thereby creating a gap between the bar and the recess;
whereby expansible material is extendable through the first area and the second area and the gap, such that the expansible material is securable at least in part by at least one protuberance and the bar.

15. The mechanism of claim 14, wherein the securing mechanism further comprises:
a first edge of the wall having at least one beveled groove extending therethrough; and
whereby expansible material is extendable through at least a portion of at least one beveled groove.

16. The mechanism of claim 14, wherein the expansible material is reinforcement material.

17. The mechanism of claim 14, wherein the expansible material is baffle material.
